(19) United States
(12) Patent Application Publication
(10) Pub. No.: US 2025/0038177 A1
(43) Pub. Date: Jan. 30, 2025

(54) NEGATIVE ELECTRODE PLATE FOR LITHIUM BATTERY AND LITHIUM-ION SECONDARY BATTERY COMPRISING SAME

(71) Applicant: MURATA MANUFACTURING CO., LTD., Kyoto (JP)

(72) Inventors: Yan ZHOU, Shanghai (CN); Li WANG, Shanghai (CN); Yuli LI, Shanghai (CN)

(21) Appl. No.: 18/916,041

(22) Filed: Oct. 15, 2024

Related U.S. Application Data
(63) Continuation of application No. PCT/CN2023/078541, filed on Feb. 27, 2023.

(30) Foreign Application Priority Data
May 6, 2022 (CN) 2022104867104

(51) Int. Cl. H01M 4/36; H01M 4/02; H01M 4/133; H01M 4/48; H01M 4/587; H01M 4/62; H01M 10/0525

(52) U.S. Cl. CPC H01M 4/364; H01M 4/133; H01M 4/48; H01M 4/587; H01M 4/622; H01M 4/625; H01M 10/0525; H01M 2004/021; H01M 2004/027

(57) ABSTRACT

A negative electrode plate for a lithium battery and a lithium-ion secondary battery including same are provided. The negative electrode plate for a lithium battery including a current collector and a negative electrode material, wherein the negative electrode material includes graphite, silicon monoxide SiOx without carbon coating, and a conductive agent including a carbon nanotube, wherein 1.6>x>0; and a lithium-ion secondary battery including the negative electrode plate.

### CROSS REFERENCE TO RELATED APPLICATIONS

The present application is a continuation of PCT patent application no. PCT/CN2023/078541, filed on Feb. 27, 2023, which claims priority to Chinese patent application no. 2022104867104, filed on May 6, 2022, the entire contents of which are incorporated herein by reference.

### BACKGROUND

The present disclosure relates to the field of lithium-ion secondary batteries, and in particular, to a negative electrode plate for a lithium-ion battery and a lithium-ion secondary battery including same.

In recent years, as electronic technology continues to evolve, the demand for battery devices that support the energy supply of electronic devices is also increasing. Today, batteries capable of storing more charge and outputting high power are needed. Conventional lead-acid batteries, nickel metal hydride batteries, and the like have been unable to meet the needs of new electronic products. Therefore, lithium batteries have attracted wide attention. In the development of lithium batteries, the capacity and performance thereof have been improved effectively.

In order to improve the energy density of a lithium-ion battery, graphite and silicon monoxide have been combined in the prior art as a negative electrode active material, and the silicon monoxide thereof is carbon-coated silicon monoxide. After the silicon monoxide is coated with carbon, the initial efficiency and cycle performance of the lithium-ion battery are improved to a certain extent; however, the initial capacity of the battery is correspondingly reduced, the negative electrode expansion effect of the battery is increased, and the material costs are increased; moreover, the uniformity of the carbon coating layer for the silicon monoxide is difficult to control, and thus side reactions between the negative electrode of the battery and the electrolyte are increased.

### SUMMARY

The present disclosure, in embodiment, relates to providing a negative electrode plate for a lithium battery and a lithium-ion secondary battery comprising same, so as to solve the problems of reduced capacity and cycle performance and large expansion ratio of the negative electrode of a lithium-ion battery to the negative electrode plate in the prior art.

In an embodiment, the present disclosure provides a negative electrode plate for a lithium battery. The negative electrode plate comprises a current collector and a negative electrode material. The negative electrode material comprises graphite, silicon monoxide SiOx without carbon coating, and a conductive agent comprising a carbon nanotube, wherein 1.6>x>0.

Further, in the negative electrode plate in an embodiment, the silicon monoxide is in an amorphous state or a low crystalline state.

Further, in the negative electrode plate in an embodiment, the content of SiO₂ in the silicon monoxide is preferably <55%, and preferably <45% by mole.

Further, in the negative electrode plate in an embodiment, when the silicon monoxide is in a low crystalline state, the size of the Si crystal in the silicon monoxide is ≤5 nm, and preferably ≤1 nm.

Further, in the negative electrode plate in an embodiment, when the silicon monoxide is in a low crystalline state, the XRD of SiO₂ crystal in the silicon monoxide has a full width at half maximum at 20 of 26-27° of <1.5°.

Furthermore, in the negative electrode plate in an embodiment, the particle size D₅₀ of the silicon monoxide is 1 μm<D50<10 μm, and when the particle size D₅₀ of the silicon monoxide is 4 μm<D50<10 μm, particles with the particle size of <2 μm account for 20%-50%, or when the particle size D₅₀ of the silicon monoxide is 2 μm<D50<4 μm, particles with the particle size of <2 μm account for 70%-80%.

Further, in the negative electrode plate in an embodiment, the specific surface area of the silicon monoxide is 1-5 m²/g.

Further, in the negative electrode plate in an embodiment, the carbon nanotube has a length of 1-30 μm and a diameter of 1-20 μm, wherein the aspect ratio of the carbon nanotube is 1:1-10:1, and preferably 3:1-10:1.

Further, in the negative electrode plate in an embodiment, the amount of the carbon nanotube in the negative electrode material is 0.005%-1%, and preferably 0.02%-0.2% by weight based on the total solid weight of the negative electrode material.

Further, in the negative electrode plate in an embodiment, the graphite in the negative electrode plate is selected from natural graphite, artificial graphite or a mixture thereof, D/G of the graphite is in the range of 0.04-1, preferably 0.3-0.9, and the electrical conductivity of the graphite is >1 s/cm when the bulk density is 1.6-1.7 g/cm³, and >40 s/cm when the bulk density is 2.2-2.3 g/cm³.

Further, in the negative electrode plate in an embodiment, the negative electrode plate further comprises a binder, the binder comprises PVDF-, PAA-, SBR-, CMC-based binder, or a combination thereof, and the amount of the binder in the negative electrode material is 2-4% by weight based on the total solid weight of the negative electrode material.

Further, in the negative electrode plate in an embodiment, the conductive agent further comprises conductive carbon black, conductive graphite, vapor grown carbon fiber, or a combination thereof, and the amount of the conductive agent in the negative electrode material is 1%-3% by weight based on the total solid weight of the negative electrode material.

According to another embodiment of the present disclosure, provided is a lithium-ion secondary battery comprising a positive electrode plate, the negative electrode plate in the described aspects of the present disclosure, a separator, and an electrolyte.

By means of the negative electrode plate for a lithium-ion battery and the lithium-ion secondary battery including same in the present disclosure, the effect of improving the electrochemical performance, especially the capacity, the cycle performance and the expansion ratio of the lithium-ion battery is achieved according to an embodiment.

### BRIEF DESCRIPTION OF THE FIGURES

The accompanying drawings, which form a part of the present application, are used to provide a further understanding of the present disclosure. The schematic embodiments of the present disclosure and the description thereof are used to explain the present disclosure, and do not form improper limits to the present disclosure.

FIG. 1 is a photograph comparing the dispersion performance in water of the silicon monoxide material without carbon coating according to the present disclosure (right) and a carbon-coated silicon monoxide material of the prior art (left).

FIG. 2 is a graph showing the initial and second capacity and initial efficiency of lithium batteries comprising a carbon-coated silicon monoxide material of the prior art (left) and lithium batteries comprising the silicon monoxide material without carbon coating according to the present disclosure (right) and different contents of carbon nanotubes.

FIG. 3 is a graph showing the capacity and capacity retention at different discharge rates of lithium batteries comprising carbon-coated silicon monoxide materials of the prior art (lower most broken line SiOx/C in left and right panels) and lithium batteries comprising the silicon monoxide material without carbon coating according to the present disclosure (upper three broken lines SiOx-0.1% SWCNT, SiOx-0.05% SWCNT, and SiOx-0.03% SWCNT in left and right panels) and different contents of the carbon nanotube.

FIG. 4 is a graph showing the cycle performance of lithium batteries comprising carbon-coated silicon monoxide materials in the prior art (lower most broken line SiOx/C in left and right panels) and lithium batteries comprising the silicon monoxide material without carbon coating according to the present disclosure (upper three broken lines SiOx-0.1% SWCNT, SiOx-0.05% SWCNT, and SiOx-0.03% SWCNT in left and right panels) and different contents of the carbon nanotube.

### DETAILED DESCRIPTION

The present disclosure will be described below including with reference to the drawings according to an embodiment. It is noted that the embodiments of the present disclosure and the characteristics in the embodiments can be combined.

As explained in the background, graphite and silicon monoxide are combined and used as a negative electrode active material for lithium batteries, and silicon monoxide used in the prior art is a carbon-coated silicon monoxide. After coating with carbon, the silicon monoxide reduces the initial capacity, increases the expansion effect of the electrode and increases the material costs, and the uniformity of the carbon coating layer is difficult to control, resulting in increased side reactions with an electrolyte.

With regard to the described problem, the present disclosure provides, in an embodiment, a negative electrode plate for a lithium battery, wherein an active material silicon monoxide uses a mixture of an uncoated silicon monoxide and a small amount of carbon nanotube having good electrical conductivity to replace carbon-coated silicon monoxide materials, so as to improve the electrochemical performance of the carbon-coated silicon monoxide materials in the prior art.

According to an embodiment of the present application, a negative electrode plate for a lithium battery is provided. The negative electrode plate comprises a current collector and a negative electrode material. The negative electrode material includes graphite, a silicon monoxide without carbon coating, and a conductive agent comprising a SiOx carbon nanotube, wherein 1.6>x>0.

In a negative electrode material of a lithium battery, in an embodiment, combining a silicon monoxide without carbon coating with a carbon nanotube greatly improves the wettability of an electrolyte to the negative electrode, thereby greatly improves the discharge capacity, the rate performance and the cycle performance of the lithium battery, and at the same time, the battery costs are reduced. In addition, the silicon monoxide material without carbon coating has a relatively small specific surface area and an internal crystal silicon size, and using same as an active material can reduce expansion of the negative electrode plate and reduce side reactions with the electrolyte.

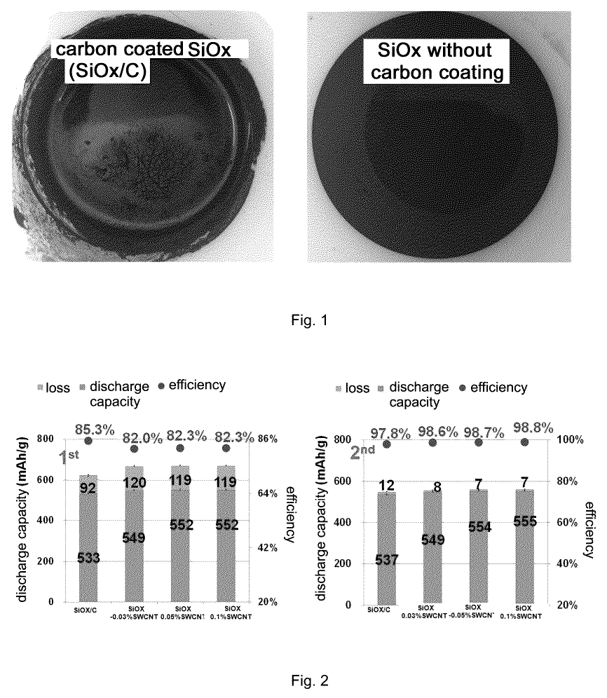

For example, as shown in FIG. 1, 3 g of a carbon-coated silicon monoxide material and 3 g of the silicon monoxide material without carbon coating were placed in two different containers respectively, and then 30 g of water was added and stirred until the powder was dispersed. The dispersed state of the powder in water was observed. Under the same slurry dispersion conditions, compared with the carbon-coated silicon monoxide materials in the prior art, the silicon monoxide without carbon coating according to the present disclosure has significantly better dispersion in water, and does not have problems of the carbon-coated silicon monoxide such as agglomeration in water. Although not wishing to be bound by theory, it is believed that the carbon layer on the surface of the carbon-coated silicon monoxide is hydrophobic, while the silicon monoxide without carbon coating is less hydrophobic than the carbon-coated silicon monoxide, and therefore has better dispersibility in water. Improving the dispersibility of the negative electrode material helps to improve the electrochemical performance of the battery and consistency and safety of the battery. In addition, as the silicon monoxide without carbon coating has better wettability with water, the electrode paste prepared therefrom has better workability and coating uniformity.

In addition, as there is no carbon coating layer, the silicon monoxide without carbon coating according to the present disclosure does not have problems such as decrease in initial capacity, increase in expansion of the negative electrode plate, and an increase in side reactions due to the carbon coating. At the same time, the carbon nanotube material with good conductivity is used as a conductive agent, thereby improves the discharge capacity, rate performance and cycle performance.

In an embodiment of the present application, the silicon monoxide is in an amorphous state or a low crystalline state.

In an embodiment of the present application, the content of SiO₂ in the silicon monoxide is <55%, and preferably <45% by mole.

In a preferred embodiment, when the silicon monoxide is in the low crystalline state, the size of the Si crystal in the silicon monoxide is ≤5 nm, and preferably ≤1 nm.

In a preferred embodiment, when the silicon monoxide is in the low crystalline state, the XRD of SiO₂ crystal in the silicon monoxide has a full width at half maximum at 20 of 26-27° of <1.5°.

The presence of a small amount of silicon in the silicon monoxide material can improve the initial efficiency of the battery, and the presence of a small amount of silicon dioxide can reduce the expansion during charging of the battery, thereby improving the stability of the battery and the cycle characteristics of the battery. However, if the grain size in the silicon monoxide is too large, a significant volume effect will be caused, which leads to more expansion of the negative electrode plate in the battery, thereby affecting the electrochemical performance. At the same time, if the content of silicon dioxide is too high, the initial capacity, efficiency and rate performance of the battery will be reduced.

In an embodiment of the present application, the particle size D₅₀ of the silicon monoxide is 1 μm<D50<10 μm, and when the particle size D₅₀ of the silicon monoxide is 4 μm<D50<10 μm, particles with the particle size of <2 μm account for 20%-50%, or when the particle size D₅₀ of the silicon monoxide is 2 μm<D50<4 μm, particles with the particle size of <2 μm account for 70%-80%.

The particle size of the silicon monoxide within the foregoing range can reduce expansion of the negative electrode material during charging of the battery, and improve the cycle life of the battery. If the particle size is too large, a significant volume effect will be caused, which leads to more expansion of the negative electrode plate during the battery charging process; and if the particle size is too small, particles of the negative electrode active material are difficult to be dispersed, which will affect the dispersion performance of the slurry, and may cause an increase in side reactions of the battery.

In an embodiment of the present application, the specific surface area of the silicon monoxide is 1-5 m²/g.

As described above, the silicon monoxide material without carbon coating according to the present disclosure has a small specific surface area and can reduce expansion of the electrode plate and side reactions with an electrolyte when used as an active material. In contrast, when the specific surface area of the silicon monoxide is too large, side reactions can be increased.

In an embodiment of the present application, the carbon nanotube has a length of 1-30 μm and a diameter of 1-20 μm, wherein the aspect ratio (ratio of length to diameter) of the carbon nanotube is 1:1-10:1, and preferably 3:1-10:1.

In a preferred embodiment, the carbon nanotube is a single wall carbon nanotube.

The carbon nanotube has strong electrical conductivity, can improve the electrical conductivity of the negative electrode, and also has excellent lithium intercalation performance in a lithium-ion battery. The use of the carbon nanotube for the negative electrode material of the present disclosure can therefore improve the electrochemical performance of the battery. Moreover, if the length of the carbon nanotube is too short, the active material cannot be well connected, and a conductive network cannot be effectively constructed, which in turn affects the electrochemical performance; and if the length of the carbon nanotube is too long and the diameter is too small, the carbon nanotube will agglomerate, affecting the dispersion performance in the negative electrode slurry and the electrochemical performance of the battery.

In an embodiment of the present application, the amount of the carbon nanotube in the negative electrode material is 0.005%-1%, and preferably 0.02%-0.2% by weight based on the total solid weight of the negative electrode material.

As described in detail in examples below, the use of a combination of the carbon nanotube and the silicon monoxide without carbon coating in an amount within the range of the present disclosure (a mixture of the two) can improve the initial capacity, the capacity and efficiency of the second cycle, and the rate and cycle performance of the battery.

In an embodiment of the present application, the graphite in the negative electrode plate is selected from natural graphite, artificial graphite, or a mixture thereof, D/G of the graphite is in the range of 0.04-1, and preferably 0.3-0.9, and the electrical conductivity of the graphite is >1 s/cm at a bulk density of 1.6-1.7 g/cm³ and >40 s/cm at a bulk density of 2.2-2.3 g/cm³. D/G of the graphite refers to a peak intensity ratio of a D peak (D-band) to a G peak (G-band) of a Raman spectrum of graphite, wherein the D peak of the Raman spectrum of graphite is a disorder peak caused by sp2 of the graphite, and is derived from vibration of edge of graphite carbon crystal and is near a wavelength of 1360-1, and the G peak of the Raman spectrum of graphite is a typical Raman peak of bulk crystalline graphite near a wavelength of 1585 cm⁻¹, and is the fundamental vibrational mode of graphite crystals.

In an embodiment of the present application, the negative electrode slurry further comprises a binder, the binder comprises PVDF-, PAA-, SBR-, CMC-based binder, or any combination of two or more thereof, and the amount of the binder in the negative electrode material is 2%-4% by weight based on the total solid weight of the negative electrode material.

In an embodiment of the present application, the conductive agent further comprises conductive carbon black, conductive graphite, a vapor grown carbon fiber, or a combination thereof, and the amount of the conductive agent in the negative electrode material is 1%-3% by weight based on the total solid weight of the negative electrode material.

According to an embodiment of the present disclosure, provided is a lithium-ion secondary battery comprising a positive electrode plate, a negative electrode plate in each of the above aspects of the present disclosure, a separator, and an electrolyte.

In an embodiment of the present disclosure, the lithium-ion secondary battery of the present disclosure is prepared by the following steps.

Preparation of a negative electrode plate: a negative electrode active material, a conductive agent, a binder and a solvent were stirred to prepare a negative electrode slurry. The negative electrode slurry was then coated onto the negative electrode current collector, dried and press-molded to form a negative electrode plate.

Formulation of an electrolyte: an organic solvent, a lithium salt, and an additive were mixed to prepare an electrolyte.

Assembly of a battery: the prepared negative electrode plate, a separator, a lithium sheet, and a battery housing were stacked in sequence, 100 ml of the electrolyte was injected, and sealing was performed to assemble a half-cell.

The present disclosure will be further described in further detail including in conjunction with the following examples according to an embodiment.

### Preparation Examples

The lithium-ion batteries used in the examples were prepared by the following procedure.

The slurry of the negative electrode plate was composed of an active material, a binder, a conductive agent, a solvent, and the like. The active material accounts for 95%-97%, the binder accounts for 2%-4%, and the conductive agent accounts for 1%-3% by solid weight. The active material consists of 75%-95% of graphite and 5%-25% of the silicon monoxide of the invention. The graphite is natural graphite or artificial graphite, or a mixture of the two. The graphite used has a D/G of 0.04-1, and preferably 0.3-0.9. The conductivity of the graphite satisfies: conductivity >1 s/cm at a bulk density of 1.6-1.7 g/cm³, and conductivity >40 s/cm at bulk density of 2.2-2.3 g/cm³. The binder is one or more of styrene-butadiene rubber (SBR), polyacrylic acid (PAA), and polyimide (PI) binders, and preferably a PAA binder. The conductive agent is a mixture of conductive carbon black, conductive graphite, a vapor grown carbon fiber, and a carbon nanotube. The carbon nanotube accounts for 0.005%-1%, and preferably 0.02%-0.2% based on the solid weight.

Specifically, 12.8 wt % of the silicon monoxide and 82.2 wt % of the graphite were pre-mixed until uniform, then 50 wt % of the total amount of the required binder was added, and stirred and mixed until uniform, then 1.2 wt % of conductive carbon black was added and stirred until uniform, then remaining 50 wt % of the binder was added, and stirred and mixed, the carbon nanotube (the amount of the carbon nanotube was as described in the following specific embodiments), and stirred and mixed, and finally, water was added to adjust the solid content to a film-drawable state. The negative electrode slurry was coated on a copper foil, dried and punched, and the prepared negative electrode plate was placed in a vacuum drying box, dried for 5 h, and removed for assembling a battery.

### Test Examples

The electrochemical performance of the prepared batteries was tested by the following methods.

Capacity test: test the battery for two cycles using a charge and discharge rate of 0.1 C and a charge and discharge voltage range of 0 V-1.5 V to obtain the initial capacity and initial efficiency and the capacity and efficiency at cycle 2.

Rate test: discharging a fully charged battery under different currents (0.2 C, 0.5 C, 1 C, 2 C, and 5 C), measuring the discharge capacity under the corresponding current, and dividing the discharge capacity by the initial capacity to obtain a corresponding capacity retention ratio under the current.

Cycle test: charging the batteries after the capacity test at a current of 0.1 C, then performing a charging and discharging cycle test using the current of 1 C, and testing the capacity retention rate of the batteries after 100 cycles. The charging/discharging cutoff voltage was 0 V-1.5 V.

Expansion ratio test of the negative electrode plate: disassembling the batteries after the cycle test, taking out the negative electrode plate and washing same with dimethyl carbonate (DMC) until clean, naturally drying same, and then performing a thickness test by using a thickness tester, and calculating according to the thickness change before and after the cycles:

Expansion ratio=(thickness of negative electrode plate after 100 cycles-thickness of negative electrode plate before cycle)/(thickness of negative electrode plate before cycle-thickness of copper foil).

### Comparison of the Negative Electrode Material of the Present Disclosure

Lithium ion batteries were prepared by the method described in the preparation example using 0.03 wt %, 0.05 wt % and 0.1 wt % of the single-walled carbon nanotube, respectively. On the other hand, lithium-ion batteries were prepared by preparing the method described in the examples using a commercially available carbon-coated silicon monoxide material in place of the silicon monoxide and carbon nanotube of the present disclosure. The prepared lithium-ion batteries above were subjected to capacity, rate and cycle tests according to the methods described in the testing examples.

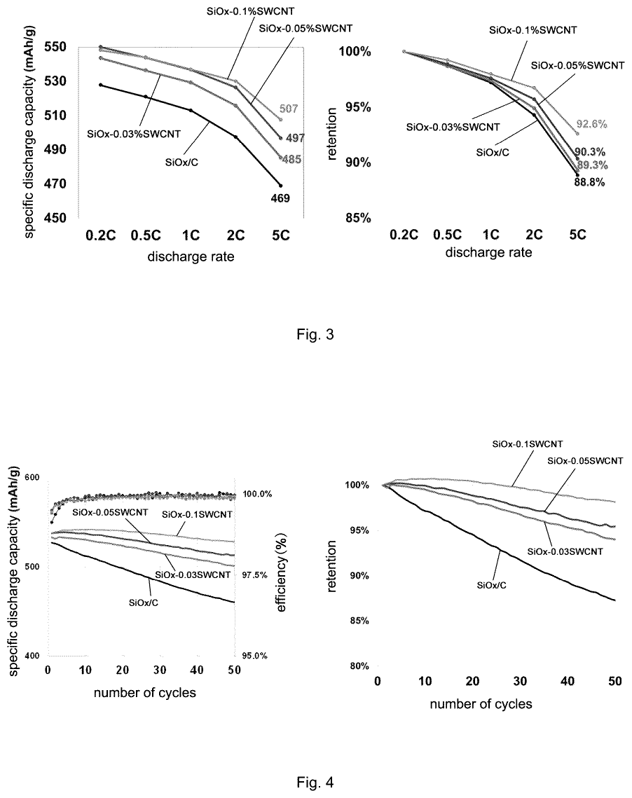

The results of the tests above are shown in FIGS. 2-4. It can be determined from FIGS. 2-4 that compared with commercially available carbon-coated silicon monoxide materials, using the combination of the uncoated silicon monoxide and the single-walled carbon nanotube of the present disclosure has advantages in terms of initial capacity, capacity and efficiency of the second cycle, and rate and cycle performance. The results demonstrate that the combination of the uncoated silicon monoxide with the carbon nanotube of the present disclosure achieves improvements in electrochemical performance compared with the carbon-coated silicon monoxide materials.

### Effect of Silicon Monoxide, Graphite and Carbon Nanotube Parameters

The effect of various parameters of the silicon monoxide, the graphite, and the carbon nanotube on battery performance is illustrated by the following examples. Examples 1-20 are lithium-ion batteries prepared using the negative electrode material of the present disclosure. Comparative Examples 1-2 are lithium-ion batteries prepared using the negative electrode material of the present disclosure that does not contain the carbon nanotube. Comparative Examples 3-4 are lithium-ion batteries prepared using the commercially available carbon-coated silicon monoxide materials. Lithium-ion batteries were prepared by the method described in the examples, using the silicon monoxide, the graphite, and the carbon nanotube having the parameters listed in Tables 1-3 below, and the prepared lithium-ion batteries were tested according to the method described in the test examples. The test results are shown in Table 4.

The test methods for the parameters shown in Tables 1˜4 are as follows:

Graphite D/G was tested using an inVia Qontor Raman spectrometer from Renishaw, with the test range being 50-3000 cm⁻¹.

Graphite conductivity was tested using PRCD1100 powder conductivity and compaction density tester from Inital Energy Science & Technology. About 1 g of graphite powder was placed in a device mold, a pressure was applied, and changes of electrical conductivity and volume density with pressure were recorded.

Si grain size was obtained by testing and fitting using a D8 XRD instrument from Bruker. XRD scanning was performed on samples at 2θ within a range of 10°-80°, then fitting was performed at 2θ within a range of 25°-32° to obtain a full width at half maximum of a Si (111) peak, and Scherrer formula was used to calculate and obtain the Si grain size.

Full width at half maximum of crystal SiO₂ was obtained using fitting of XRD test. XRD scanning was performed on samples at 2θ within a range of 10°-80°, and then fitting was performed at 2θ within a range of 26°-27° to obtain the full width at half maximum of crystal SiO₂.

SiO₂ content was tested by means of XPS. Ar ion etching was performed on samples, and when the etching depth was about 300 nm, the content of tetravalent silicon SiO₂ was obtained by peak splitting simulation of silicon peak of XPS.

Silicon monoxide particle size was tested by using a LA-960 laser particle size analyzer from Horiba, and the number of particles with the particle size of <2 μm was counted based on the number distribution.

Specific surface area was tested using the ASAP2020 surface area analyzer from Micromeritics using the N₂ adsorption method.

TABLE 1
Parameters of graphite in the negative
electrode material used in the examples

Conductivity (s/cm)

| | | bulk density | bulk density |
|---|---|---|---|
| | D/G | 1.6 g/cm³ | 2.2 g/cm³ |
| Example 1 | 0.6 | 4.3 | 52 |
| Example 2 | 0.6 | 4.3 | 52 |
| Example 3 | 0.6 | 4.3 | 52 |
| Example 4 | 0.6 | 4.3 | 52 |
| Example 5 | 0.6 | 4.3 | 52 |
| Example 6 | 0.6 | 4.3 | 52 |
| Example 7 | 0.6 | 4.3 | 52 |
| Example 8 | 0.6 | 4.3 | 52 |
| Example 9 | 0.6 | 4.3 | 52 |
| Example 10 | 0.6 | 4.3 | 52 |
| Example 11 | 0.6 | 4.3 | 52 |
| Example 12 | 0.6 | 4.3 | 52 |
| Example 13 | 0.4 | 5.9 | 51.3 |
| Example 14 | 0.95 | 0.8 | 39 |
| Example 15 | 0.03 | 4 | 54 |
| Example 16 | 0.6 | 4.3 | 52 |
| Example 17 | 0.6 | 4.3 | 52 |
| Example 18 | 0.6 | 4.3 | 52 |
| Example 19 | 0.6 | 4.3 | 52 |
| Example 20 | 0.6 | 4.3 | 52 |
| Comparative | 0.6 | 4.3 | 52 |
| Example 1 | | | |
| Comparative | 0.6 | 4.3 | 52 |
| Example 2 | | | |
| Comparative | 0.6 | 4.3 | 52 |
| Example 3 | | | |
| Comparative | 0.6 | 4.3 | 52 |
| Example 4 | | | |
| Comparative | 0.6 | 4.3 | 52 |
| Example 5 | | | |
| Comparative | 0.6 | 4.3 | 52 |
| Example 6 | | | |

TABLE 2
Parameters of the silicon monoxide in the negative electrode material used in the examples

| | | | | proportion of particles | proportion of particles | |
|---|---|---|---|---|---|---|
| | | Si | Full width at half | with size <2 μm when | with size <2 μm when | Specific |
| | | grain | maximum of | particle diameter of | particle diameter of | surface |
| | SiO₂ | size | crystal SiO₂ at | silicon monoxide is | silicon monoxide is | area |
| | content | (nm) | 26-27° (°) | 4 μm < D50 < 10 μm, | 2 μm < D50 < 4 μm, | m²/g |
| Example 1 | 5% | 3.6 | 0 | 30% | NA | 2.7 |
| Example 2 | 5% | 3.6 | 0.4 | 50% | NA | 3.8 |
| Example 3 | 35% | 0.9 | 0.4 | 30% | NA | 2.7 |
| Example 4 | 35% | 0.9 | 0 | 30% | NA | 2.7 |
| Example 5 | 35% | 0.9 | 1.6 | 30% | NA | 2.7 |
| Example 6 | 35% | 0 | 0 | 30% | NA | 2.7 |
| Example 7 | 35% | 0.9 | 0.4 | 0% | NA | 1.7 |
| Example 8 | 50% | 0.9 | 0.4 | 30% | NA | 2.7 |
| Example 9 | 35% | 0.9 | 2 | NA | 85% | 4.8 |
| Example 10 | 35% | 0 | 0 | NA | 75% | 4.5 |
| Example 11 | 35% | 0.9 | 0.4 | NA | 50% | 4 |
| Example 12 | 35% | 3.6 | 0 | NA | 75% | 4.5 |
| Example 13 | 35% | 0 | 0.4 | 30% | NA | 2.7 |
| Example 14 | 35% | 0 | 0.4 | 30% | NA | 2.7 |
| Example 15 | 35% | 0.9 | 0.4 | 30% | NA | 2.7 |
| Example 16 | 35% | 0 | 0 | 30% | NA | 2.7 |
| Example 17 | 35% | 0 | 0 | 30% | NA | 2.7 |
| Example 18 | 35% | 0 | 0 | 30% | NA | 2.7 |
| Example 19 | 35% | 0 | 0 | 30% | NA | 2.7 |
| Example 20 | 35% | 0 | 0.4 | 30% | NA | 2.7 |
| Comparative | 35% | 0.9 | 0.4 | 30% | NA | 2.7 |
| Example 1 | | | | | | |
| Comparative | 35% | 0 | 0 | NA | 75% | 4.5 |
| Example 2 | | | | | | |
| Comparative | 5% | 3.7 | 0 | 30% | NA | 8.5 |
| Example 3 | | | | | | |
| Comparative | 47% | 0 | 0 | 35% | NA | 1.5 |
| Example 4 | | | | | | |
| Comparative | 57% | 0 | 0 | 30% | NA | 2 |
| Example 5 | | | | | | |
| Comparative | 4% | 6 | 0 | 30% | NA | 2.7 |
| Example 6 | | | | | | |

TABLE 3
Parameters of the carbon nanotube in the negative
electrode material used in the examples

| | | Tube | Addition |
|---|---|---|---|
| | Tube diameter (nm) | length (nm) | amount (wt %) |
| Example 1 | 1.5 | 5-10 | 0.10 |
| Example 2 | 1.5 | 5-10 | 0.10 |
| Example 3 | 1.5 | 5-10 | 0.10 |
| Example 4 | 1.5 | 5-10 | 0.10 |
| Example 5 | 1.5 | 5-10 | 0.10 |
| Example 6 | 1.5 | 5-10 | 0.10 |
| Example 7 | 1.5 | 5-10 | 0.10 |
| Example 8 | 1.5 | 5-10 | 0.10 |
| Example 9 | 1.5 | 5-10 | 0.10 |
| Example 10 | 1.5 | 5-10 | 0.10 |
| Example 11 | 1.5 | 5-10 | 0.10 |
| Example 12 | 1.5 | 5-10 | 0.10 |
| Example 13 | 1.5 | 5-10 | 0.10 |
| Example 14 | 1.5 | 5-10 | 0.10 |
| Example 15 | 1.5 | 5-10 | 0.10 |
| Example 16 | 1.5 | 5-10 | 0.004 |
| Example 17 | 1.5 | 5-10 | 0.01 |
| Example 18 | 1.5 | 5-10 | 0.50 |
| Example 19 | 1.5 | 5-10 | 1.10 |
| Example 20 | 25 | 20-30 | 0.10 |
| Comparative | NA | NA | 0 |
| Example 1 | | | |
| Comparative | NA | NA | 0 |
| Example 2 | | | |
| Comparative | NA | NA | 0 |
| Example 3 | | | |
| Comparative | NA | NA | 0 |
| Example 4 | | | |
| Comparative | 1.5 | 5-10 | 0.1 |
| Example 5 | | | |
| Comparative | 1.5 | 5-10 | 0.1 |
| Example 6 | | | |

TABLE 4
Performance of lithium-ion batteries of Examples 1-20 and Comparative Examples 1-4

| | Initial | Initial | | | | 100 cycle | |
|---|---|---|---|---|---|---|---|
| | discharge | discharge | Capacity at | Efficiency at | Discharge | | Expansion of |
| | capacity | efficiency | cycle 2 | cycle 2 | Rate at 5 C | Retention | electrode |
| | (mAh/g) | (%) | (mAh/g) | (%) | (%) | (%) | plate (%) |
| Example 1 | 532 | 84 | 535 | 97 | 86.5 | 81 | 34 |
| Example 2 | 530 | 83.8 | 534 | 97 | 85 | 83 | 32 |
| Example 3 | 552 | 82.9 | 555 | 99.2 | 92.5 | 92.1 | 27 |
| Example 4 | 553 | 83.3 | 555 | 99.3 | 93 | 92 | 27 |
| Example 5 | 550 | 83.2 | 551 | 99.2 | 92 | 92 | 26 |
| Example 6 | 552 | 83.1 | 554 | 99.2 | 92.7 | 92.2 | 25 |
| Example 7 | 551 | 82.5 | 554 | 99.1 | 82 | 80 | 34 |
| Example 8 | 540 | 82 | 542 | 99 | 87 | 88 | 26 |
| Example 9 | 549 | 83.6 | 551 | 99.2 | 95.5 | 96 | 23 |
| Example 10 | 554 | 83.3 | 554 | 99.4 | 96 | 94 | 26 |
| Example 11 | 550 | 83.2 | 552 | 99.3 | 93 | 92 | 27 |
| Example 12 | 533 | 83.7 | 533 | 99.1 | 87 | 89 | 32 |
| Example 13 | 549 | 83 | 550 | 99.2 | 91.5 | 90 | 29 |
| Example 14 | 550 | 83.2 | 552 | 99.1 | 90 | 89 | 30 |
| Example 15 | 547 | 82.5 | 548 | 99.2 | 92 | 91 | 28 |
| Example 16 | 535 | 80 | 537 | 97.2 | 80 | 83 | 29 |
| Example 17 | 547 | 82 | 549 | 99.1 | 89.3 | 87 | 27 |
| Example 18 | 545 | 81 | 548 | 99 | 88.5 | 83 | 27 |
| Example 19 | 530 | 82 | 527 | 96 | 85 | 81 | 27 |
| Example 20 | 542 | 80 | 543 | 99.1 | 85 | 85 | 30 |
| Comparative | 530 | 79 | 532 | 95 | 75 | 80 | 30 |
| Example 1 | | | | | | | |
| Comparative | 535 | 81 | 536 | 96 | 80 | 85 | 28 |
| Example 2 | | | | | | | |
| Comparative | 533 | 85 | 537 | 97.8 | 88.8 | 81 | 36 |
| Example 3 | | | | | | | |
| Comparative | 550 | 83 | 553 | 98 | 80 | 75 | 28 |
| Example 4 | | | | | | | |
| Comparative | 537 | 82 | 538 | 99 | 85 | 89 | 25 |
| Example 5 | | | | | | | |
| Comparative | 529 | 83.5 | 530 | 96 | 85 | 75 | 40 |
| Example 6 | | | | | | | |

It can be determined from Table 4 that, firstly, compared with Comparative Examples 1-4, the batteries made of the negative electrode material of the present disclosure are significantly improved in terms of the efficiency at the second cycle, the 5 C discharge rate, and the cycle retention ratio, and again, it is proved that the combination of the uncoated silicon monoxide of the present disclosure and the carbon nanotube has improved electrochemical performance compared with the carbon-coated silicon monoxide material.

Regarding the influence of the parameters of the graphite on the battery performance, it can be determined from examples 13 to 15 that when graphite has D/G and conductivity within the range of the present disclosure, better performance is achieved in terms of efficiency at cycle 2, 5 C discharge rate, cycle retention ratio, and the expansion ratio of the negative electrode plate.

With regard to the influence of the SiO₂ content on the battery performance, it can be determined by comparing Example 3 with Example 8 and Comparative Examples 4 and 5 that when the SiO₂ content is higher than the range of the present disclosure, all battery performances are degraded except the expansion ratio of the negative electrode plate.

With regard to the influence of the Si grain size on the battery performance, it can be determined by comparing Examples 6 and 10 with Examples 1, 2 and 12 and Comparative Examples 3 and 6 that when the Si grain size is higher than the range of the present disclosure, the performance of the battery is deteriorated, and in particular, the expansion ratio of the negative electrode plate is significantly deteriorated. It is noted that the Si grain size of 0 in Table 2 represents the case where crystalline Si is not present.

Regarding the influence of the full width at half maximum at 26-27° C. of crystalline SiO₂ on the battery performance, it can be determined from the comparison among Examples 3, 4 and 5 and Examples 9 and 10 that a lower full width at half maximum leads to an improvement in the initial capacity and capacity at cycle 2 and the 5C discharge rate of the battery. It is noted that a full width at half maximum of 0 in Table 2 represents the case where crystalline SiO₂ is not present.

Regarding the influence of the particle size of the silicon monoxide on the battery performance, it can be determined from the comparison between Examples 3 and 7 that the proportion of particles with the particle size <2 μm within the range of the present disclosure leads to significant improvement in 5 C discharge rate, cycle retention ratio, and expansion ratio. As can be determined from comparison among Examples 9, 10 and 11, the proportion of particles having a particle size <2 μm within the range of the present disclosure results in improvement in initial capacity and capacity at cycle 2 and the 5C discharge rate of the battery.

Regarding the influence of the specific surface area on the battery performance, it can be determined from the comparison between the examples of the present disclosure and Comparative Example 3 that the specific surface area of the silicon monoxide higher than the range of the present disclosure leads to the deterioration of the electrode expansion ratio.

Regarding the influence of the parameters of the carbon nanotube on the battery performance, it can be determined from Examples 16 to 20 that when the content of the carbon nanotube is lower or higher than the range of the present disclosure, the initial capacity, the capacity at cycle 2, the efficiency at cycle 2, and the 5 C discharge rate of the battery are significantly deteriorated. When the size and the aspect ratio of the carbon nanotube are out of the range of the present disclosure, properties of the battery, particularly 5 C discharge rate and expansion ratio, are deteriorated.

By using the combination of the non-coated silicon monoxide according to the present disclosure and the carbon nanotube as the negative electrode material, improvement in electrochemical performance of the battery is obtained compared to the carbon-coated silicon monoxide material in the prior art.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A negative electrode plate for a lithium battery, the negative electrode plate comprising a current collector and a negative electrode material comprising graphite, silicon monoxide SiOx without a carbon coating, and a conductive agent comprising a carbon nanotube, wherein 1.6>x>0.

2. The negative electrode plate according to claim 1, wherein the silicon monoxide is in an amorphous state or a low crystalline state.

3. The negative electrode plate according to claim 1, wherein a content of SiO₂ in the silicon monoxide is <55% by mole.

4. The negative electrode plate according to claim 2, wherein when the silicon monoxide is in a low crystalline state, and wherein a size of a Si crystal in the silicon monoxide is ≤5 nm.

5. The negative electrode plate according to claim 2, wherein when the silicon monoxide is in a low crystalline state, and wherein a XRD of a SiO₂ crystal in the silicon monoxide has a full width at half maximum at 20 of 26-27° of <1.5°.

6. The negative electrode plate according to claim 1, wherein a particle size D₅₀ of the silicon monoxide is 1 μm<D50<10 μm, and when the particle size D₅₀ of the silicon monoxide is 4 μm<D50<10 μm, particles with the particle size of <2 μm account for 20%-50%, or when the particle size D₅₀ of the silicon monoxide is 2 μm<D50<4 μm, particles with the particle size of <2 μm account for 70%-80%.

7. The negative electrode plate according to claim 1, wherein a specific surface area of the silicon monoxide is 1-5 m²/g.

8. The negative electrode plate according to claim 1, wherein the carbon nanotube has a length of 1-30 μm and a diameter of 1-20 μm, and an aspect ratio of the carbon nanotube is 1:1-10:1.

9. The negative electrode plate according to claim 1, wherein an amount of the carbon nanotube in the negative electrode material is 0.005%-1% by weight based on a total solid weight of the negative electrode material.

10. The negative electrode plate according to claim 1, wherein the graphite in the negative electrode plate is selected from natural graphite, artificial graphite, or a mixture thereof, and a ratio D/G of a peak intensity of D peak to a peak intensity of G peak of a Raman spectrum of the graphite is in a range of 0.04-1, and wherein a conductivity of the graphite is >1 s/cm at a bulk density of 1.6-1.7 g/cm³ and >40 s/cm at a bulk density of 2.2-2.3 g/cm³.

11. The negative electrode plate according to claim 1, wherein the negative electrode plate further comprises a binder, wherein the binder comprises PVDF, PAA, SBR, CMC, or any combination of two or more thereof, and wherein an amount of the binder in the negative electrode material is 2%-4% by weight based on a total solid weight of the negative electrode material.

12. The negative electrode plate according to claim 1, wherein the conductive agent further comprises conductive carbon black, conductive graphite, vapor grown carbon fiber, or any combination of two or more thereof, and wherein an amount of the conductive agent in the negative electrode material is 1%-3% by weight based on a total solid weight of the negative electrode material.

13. A lithium-ion secondary battery, comprising a positive electrode plate, a negative electrode plate, a separator and an electrolyte, wherein the negative electrode plate is the negative electrode plate according to claim 1.
